(19) United States
(12) Patent Application Publication
(10) Pub. No.: US 2007/0027716 A1
(43) Pub. Date: Feb. 1, 2007

(54) COORDINATION OF ACCESS TO HEALTHCARE PROVIDERS

(75) Inventor: John J. Pembroke, Evergreen, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: John J. Pembroke, Evergreen, CO (US)

(21) Appl. No.: 11/458,575

(22) Filed: Jul. 19, 2006

Related U.S. Application Data
(60) Provisional application No. 60/704,177, filed on Jul. 28, 2005.

(51) Int. Cl. G06Q 10/00; G06Q 40/00

(52) U.S. Cl. 705/2; 705/37

(57) ABSTRACT

Methods and systems are provided for coordinating an electronic healthcare application request between a healthcare purchaser and at least one of multiple healthcare providers. Selection criteria are received from the healthcare providers. Personal information is received from the healthcare purchaser at a coordination system over a public network. The personal information is filtered to identify the healthcare providers who have selection criteria consistent with the personal information. The personal information is transmitted over the public network to a computer system operated for the identified healthcare providers.

### CROSS REFERENCE TO RELATED APPLICATION

This application is a nonprovisional of, and claims the benefit of the filing date of, U.S. Prov. Pat. Appl. No. 60/704,177, entitled “COORDINATION OF ACCESS TO HEALTHCARE PROVIDERS,” filed Jul. 28, 2005 by John J. Pembroke, the entire disclosure of which is incorporated herein by reference for all purposes.

### BACKGROUND OF THE INVENTION

This application relates generally to providing access to healthcare providers. More specifically, this application relates to methods and systems for coordinating access to healthcare providers.

It is commonly known that medical and healthcare expenses are increasing rapidly. Currently, the average premium for a family medical insurance policy in the United States is $9086/year. The average annual out-of-pocket expenses for healthcare in the United States is $2664. Medicare managed-care plans will pay an estimated $1964 in average annual out-of-pocket expenses. On average, seniors spend about $2300 per year on medicines and drugs. While these costs are already high, they are also increasing at rates that generally exceed average inflation rates, making their impact even more significant. Furthermore, the impact of these costs may sometimes take the form of a sudden unexpected cost that arises as a result of an unanticipated illness or accident.

The continued escalation in these expenses has resulted in greater sensitivity among purchasers of healthcare services to identify providers that are able to provide the services they desire at the level of quality they need for a price they consider acceptable. Current methods for identifying such providers, to the extent they even exist, are crude. There is accordingly a general need in the art for improved methods and systems for coordinating access to healthcare providers by those purchasing healthcare services.

### BRIEF SUMMARY OF THE INVENTION

Embodiments of the invention thus provide methods and systems for coordinating an electronic healthcare application request between a healthcare purchaser and at least one of a plurality of healthcare providers. Selection criteria are received from the plurality of healthcare providers. Personal information is received from the healthcare purchaser at a coordination system over a public network. The personal information is filtered to identify the at least one of the plurality of healthcare providers. Each of the at least one of the healthcare providers has selection criteria consistent with the personal information. The personal information is transmitted over the public network to a computer system operated for the at least one of the plurality of healthcare providers.

In some instances, the personal information comprises health information.

In one embodiment, the personal information is transmitted over the public network to an actuary system. An actuarial score is received from the actuarial system. The personal information is filtered to ensure that the actuarial score is consistent with the selection criteria of the at least one of the healthcare providers. Proposed terms for a relationship with the healthcare purchaser may be received from the at least one of the plurality of healthcare providers. A display may be generated for the healthcare purchaser to evaluate the proposed terms. In some instances, a modification of the proposed terms may be received for the relationship based on additional information.

In certain embodiments, these methods are used in combination with a mechanism for financing healthcare expenses using a loan secured by real property. An identification of real property financed by the healthcare purchaser is received. A total loan value for the real property and specified healthcare costs is calculated, and a loan secured by the real property for the total value is initiated.

Also, in some embodiments a debit instrument may be issued to the healthcare purchaser. The debit instrument may be used at the at least one of the plurality of healthcare providers as part of a debit transaction for payment of healthcare products and/or services.

The methods of the present invention may be embodied in a computer-readable storage medium having a computer-readable program embodied therein for directing operation of a computer system. Such a computer system may include a communications system, a processor, and a storage device. The computer-readable program includes instructions for operating the computer system to coordinate an electronic healthcare application request in accordance with the embodiments described above.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components. In some instances, a sublabel is associated with a reference numeral and follows a hyphen to denote one of multiple similar components. When reference is made to a reference numeral without specification to an existing sublabel, it is intended to refer to all such multiple similar components.

FIG. 1 is a flow diagram that provides an overview of methods of the invention;

FIG. 2A is a schematic illustration of a structure over which methods of the invention may be implemented;

FIG. 2B is a schematic illustration of a functional environment in which a bundling company may operate in accordance with embodiments of the invention;

FIG. 2C is a flow diagram illustrating a method for financing healthcare products and/or services with a loan secured by real property;

FIG. 3 is a schematic block diagram illustrating the structure of a computational unit on which methods of the invention may be embodied;

FIG. 4 is a flow diagram illustrating performing validation checks as part of the methods of the invention;

FIG. 5 is a flow diagram illustrating performing obtaining an actuarial score as part of the methods of the invention;

FIG. 6 illustrates how criteria may be matched with purchaser data to identify suitable healthcare providers;

FIG. 7 is a flow diagram illustrating how information may be filtered and transferred to healthcare providers in some embodiments of the invention; and

FIG. 8 is a flow diagram illustrating the use of a debit instrument to make payments for healthcare products and/or services from an account secured by real property.

### DETAILED DESCRIPTION OF THE INVENTION

Embodiments of the invention provide a facility that is connected with a public network to coordinate matching healthcare providers to purchasers of healthcare services. The public network may conveniently comprise the Internet. The facility is configured to provide an interface with the purchasers so that they may enter information that is then used to identify potential healthcare providers based on known information about the healthcare providers. Examples of the type of information that may be used in performing a match includes medical specialty, location, costs, insurance acceptance, and the like. In addition, the facility simplifies initial transmission of information to the healthcare providers.

An overview of methods of the invention is provided with the flow diagram of FIG. 1. At block 104, information is received from a healthcare purchaser over a public network, such as the internet. The information that is received may include identification information such as name, address, telephone number, email address, social security number, and the like; medical information such as age, sex, medical history, family medical history, current medical complaints, and the like; insurance information such as insurance provider, insurance plan number, type of coverage, and the like; and any other information that may be useful in matching the healthcare purchaser to one or more healthcare providers. The information may conveniently be collected with an interface presented to the healthcare provider, such as in the form of a fill-in questionnaire made available on a web site. The information may be received securely to ensure its privacy by using any of several suitable encryption techniques known to those of skill in the art.

Once the information is received, it may be validated at block 108 to ensure that the application provided by the healthcare purchaser is sufficiently complete to be processed and that the information provided is at least in the expected form. In some embodiments, an actuarial score may be obtained at block 112, although this is not required in all embodiments. The actuarial score provides a quantified measure of the health of the healthcare purchaser based on demographic information derived from the information received at block 104. Such an actuarial score may be useful in matching the application to potential healthcare providers and may advantageously permit the healthcare purchaser to receive favorable financial terms. For example, an individual who indicates that he does not participate in behavior known to have a strong correlation with some health risks may be a desirable patient for many healthcare providers who will be willing to offer favorable terms of service to such an individual.

At block 116, the various pieces of information collected in thus processing the application are filtered. This may be done by comparing a list of criteria defined by healthcare providers with the information in the application to determine which healthcare providers are suitable. If healthcare providers are identified in this way, the relevant portions of the application are transferred to those providers at block 120. The identified healthcare providers and the purchaser each have the opportunity to accept the formation of a relationship between them at block 124 and, if it is accepted, that information may be stored in a database at block 128.

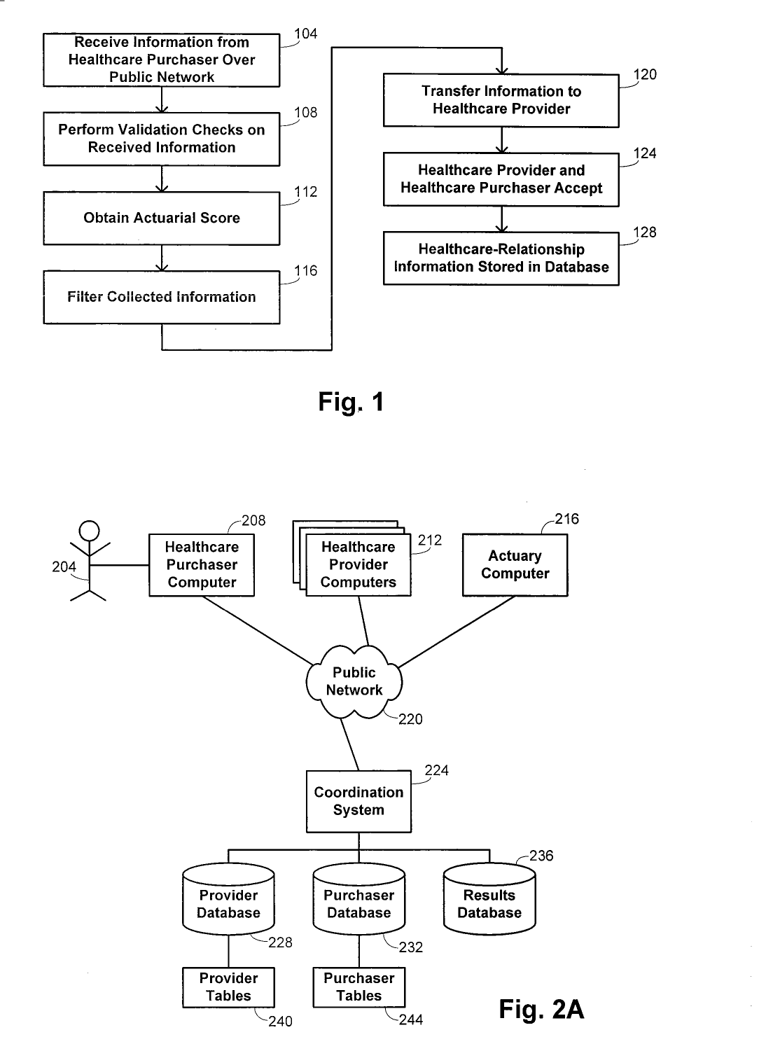

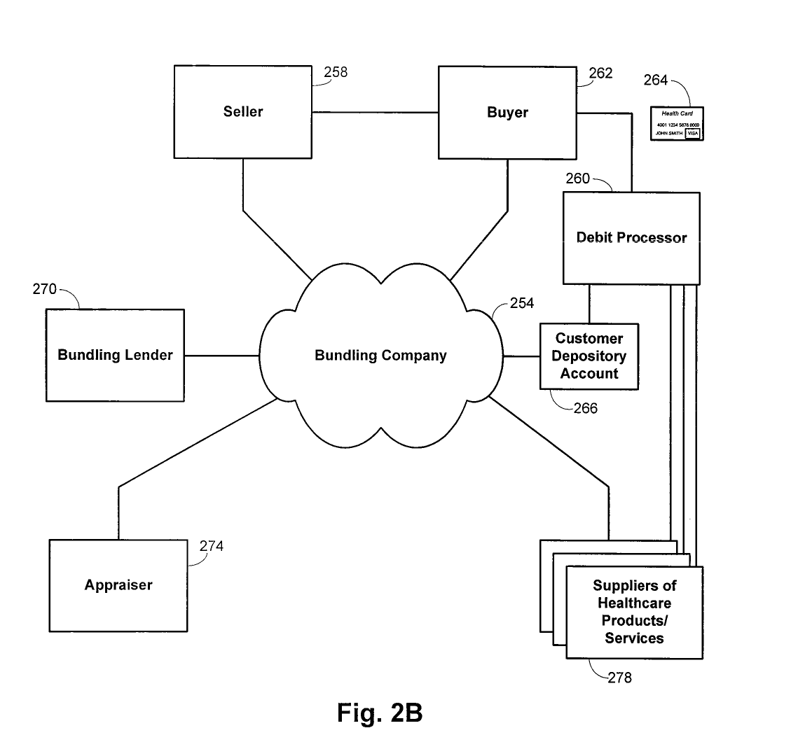

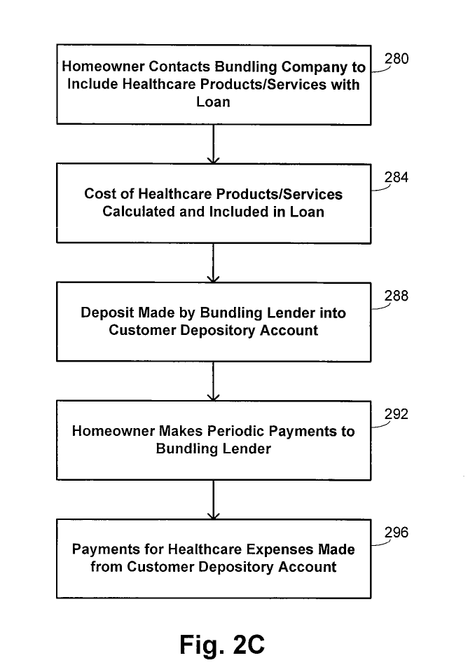

A structure that may be used to effect communications among the different parties involved is illustrated in FIG. 2A. A relationship is ultimately desired between the purchaser 204 and with one or more healthcare providers. The purchaser 204 interacts with the system through a purchaser computer 208, which may be owned by the purchaser 204 or may be another computer used by the purchaser 204 such as at a library, at work, etc. The healthcare providers similarly interact with the system through provider computers 212 and if an actuary is involved with the process, the actuary interacts with the system through an actuary computer 216. Each of these computers 208, 212, and 216 is interconnected through a public network 220 such as the Internet. Advantageously, the public network 220 may be equipped to accommodate secure transmissions using suitable encryption protocols to protect the information transmitted among the parties in implementing methods of the invention.

The public network 220 is also interfaced with a coordination system 224 that has programming instructions that correspond to the functions described in connection with FIG. 1. The coordination system 224 has access to storage devices where information used in implementing embodiments of the invention is stored. For example, a provider database 228 may house provider tables 240 that specify criteria under which the provider will be suitable for providing healthcare services. Such information might include types of medical specialties that may be accommodated, minimal service-fee structures, and the like. Similarly, a purchaser database 232 may house purchaser tables that specify criteria under which a relationship will be acceptable to the purchaser 204, with the information in the tables being drawn from the application information received at block 104 of FIG. 1. For instance, such tables might include a specification of needed medical specialties, acceptable geographical locations, acceptable service-fee structures, sex of the healthcare practitioner, and the like. Identification of matches is broadly performed by identifying consistencies between the two sets of tables 240 and 244, with the results being stored in a results database 236.

The coordination system 224 may advantageously be operated by a bundling company within a structure like that shown schematically in FIG. 2B. This drawing provides a general overview of an environment in which expenses for healthcare products and/or services may be bundled with a loan secured by real property, such as a mortgage or home equity line of credit. The secured loan is provided by a “bundling lender” 270, which is any entity that provides a real-estate-secured loan that bundles at least some products and services. Examples of entities that may be comprised by the bundling lender include mortgage brokers, mortgage bankers, commercial banks, finance companies, credit unions, insurance companies, stock brokerage firms, and individual investors; it is not necessary according to embodiments of the invention that the bundling lender 270 be associated with a financial institution. The bundling of the healthcare products and/or services is coordinated by the bundling company 254, which interacts with the bundling lender 270. The bundling company 254 may comprise any entity that offers bundleable healthcare products and/or services to be included in a loan and/or that facilitates the marketing or sale of bundleable healthcare products and services. Examples of bundling companies in certain specific embodiments include suppliers of products and services, mortgage bankers, mortgage brokers, real estate agents, real estate brokers, builders, land developers, financial planners, or various facilitators such as independent marketing entities, title companies, insurance companies, appraisers, etc.

The bundling company 254 has relationships with one or more suppliers 278 of healthcare products and services. The bundling lender 270 may negotiate discounted prices for the healthcare products and services, using its position as an interface to large volumes of such healthcare products and services for many potential customers to obtain very favorable prices. The bundling company 254 may then off the healthcare products and services to a homeowner who wishes to bundle them with the loan securing the associated real property. In the illustration, the healthcare purchaser is a buyer 262 or seller 258 rf real property such as may occur when the property is sold, but more generally the ability to bundle may be extended to any homeowner. In addition to interacting with these entities, the bundling company 254 may interact with a number of other entities, examples of which include the suppliers of healthcare products and/or services 278, appraisers 274, and one or more bundling lenders 270, who actually provide the loan.

The bundling company 254 may maintain a customer depository account 266, the use of which is described further below, although in some embodiments the customer depository account 266 may be maintained by a separate institution. There are a number of different ways in which funds in the customer depository account 266 may be accessed by the healthcare purchase to make payment for healthcare products and/or services. A convenient mechanism includes the use of a debit instrument 264 issued to the healthcare purchaser that may be presented for payment. For instance, the debit instrument could comprise a card, such as a magnetic stripe card or a smart card that has information identifying the healthcare purchaser and the customer depository account 266 encoded on the card. In some embodiments, the debit instrument is the same card used as a healthcare-insurance identification card. Payment is then coordinated by a debit processor 260 when healthcare products and/or services are purchased. In other instances, the healthcare purchaser might be provided with a set of checks that may be used to draw funds from the customer depository account 266.

While the foregoing description provides an overview of the structure used by the bundling company, further details are set forth in U.S. patent application Ser. No. 11/039,367, entitled “METHODS AND SYSTEMS FOR FINANCING EXPENSES WITH A LOAN SECURED BY REAL PROPERTY,” filed Jan. 18, 2005 by John J. Pembroke and Ser. No. 11/039,387, entitled “METHODS AND SYSTEMS FOR FINANCING HEALTHCARE EXPENSES WITH A LOAN SECURED BY REAL PROPERTY,” filed Jan. 18, 2005 by John J. Pembroke, the entire disclosures of each of which are incorporated herein by reference for all purposes. Use of a debit instrument in combination with the customer depository account 266 is described in further detail in U.S. patent application Ser. No. 11/077,990, entitled “METHODS AND SYSTEMS FOR FINANCING FOOD EXPENSES WITH A LOAN SECURED BY REAL PROPERTY,” filed Mar. 11, 2005, the entire disclosure of which is incorporated herein by reference for all purposes. The foregoing applications are sometimes referred to herein as “the prior applications.”

The flow diagram of FIG. 2C broadly illustrates steps that may be performed in establishing and using the customer depository account 266 to pay for healthcare expenses. This diagram is generalized to describe a number of different types of loan arrangements, each of which is secured by real property, with more specific descriptions being provided in the prior applications. At block 280, the homeowner contacts the bundling company 254 to initiate including the healthcare products and services as part of the loan structure for any loan secured by real property. The cost of these products and/or services is calculated at block 284 and included in the cost of the loan. Procedures included in evaluating such costs and in determining whether the bundling lender 270 will extend the loan are described in the prior applications, and may include obtaining an assessment of the real property by an appraiser, calculating a back-end ratio as a measure of the borrower's ability to repay the loan, and the like.

If the loan is approved, a deposit is made by the bundling lender 270 into the customer depository account 266 at block 288. The loan is repaid by the homeowner over time by making periodic payments to the bundling lender at block 292. Meanwhile, the funding of the customer depository account 266 permits the homeowner to make payments for the funded expenses.

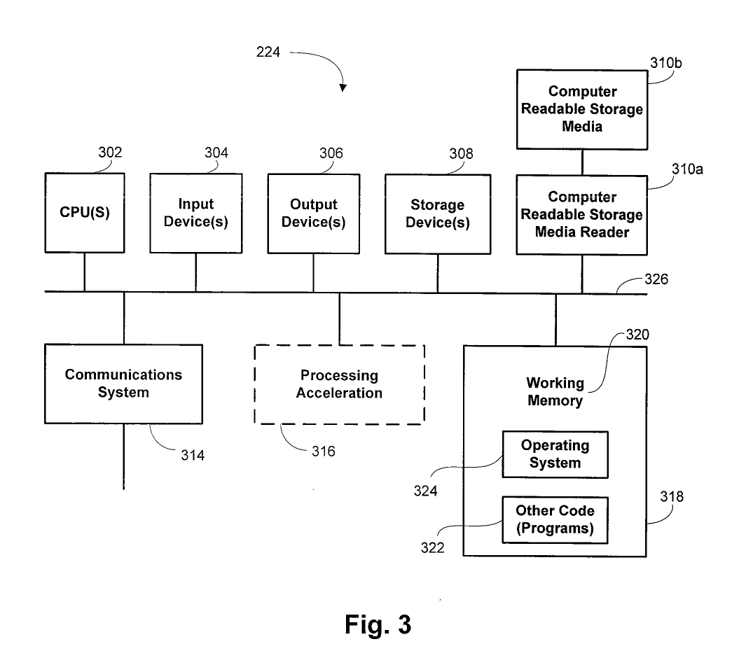

A typical structure for the coordination system 224 is shown in FIG. 3, which broadly illustrates how individual system elements may be implemented in a separated or more integrated manner. The coordination system 224 is shown comprised of hardware elements that are electrically coupled via bus 326, including a host processor 302, an input device 304, an output device 306, a storage device 308, a computer-readable storage media reader 310a, a communications system 314, a processing acceleration unit 316 such as a DSP or special-purpose processor, and a memory 318. The various databases 228, 232, and 236 are resident on the storage device 308. The computer-readable storage media reader 310a is further connected to a computer-readable storage medium 310b, the combination comprehensively representing remote, local, fixed, and/or removable storage devices plus storage media for temporarily and/or more permanently containing computer-readable information. The communications system 314 may comprise a wired, wireless, modem, and/or other type of interfacing connection and permits data to be exchanged with the public network 220 such as illustrated by the schematic arrangement of FIG. 2 to implement embodiments as described.

The coordination system 224 also comprises software elements, shown as being currently located within working memory 320, including an operating system 324 and other code 322, such as a program designed to implement methods of the invention. It will be apparent to those skilled in the art that substantial variations may be made in accordance with specific requirements. For example, customized hardware might also be used and/or particular elements might be implemented in hardware, software (including portable software, such as applets), or both. Further, connection to other computing devices such as network input/output devices may be employed.

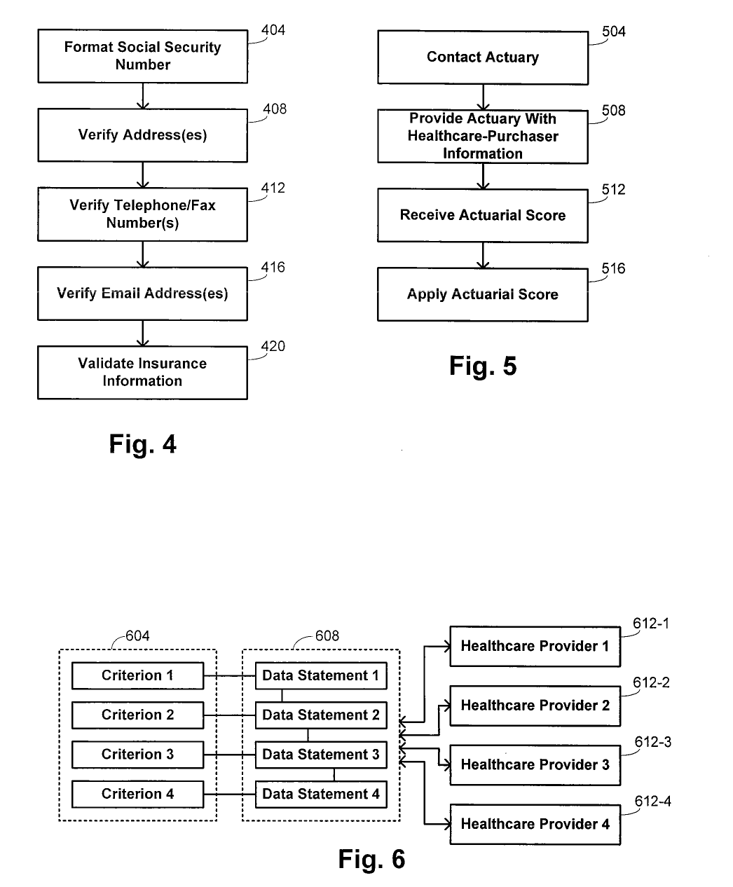

FIG. 4 provides a flow diagram that summarizes the types of steps that may be taken in performing validation checks on received information at block 108 of FIG. 1. Such validation checks may sometimes be limited to checking the format of information, but may alternatively include more active checks to ensure some level of correctness of the information. For example, the format of a social security number provided by the applicant may be checked at block 404. At one level, such a check might ensure only that the number has nine digits. At a more thorough level, the format might be checked by ensuring that the number provided has a value that is consistent with structural requirements for the number. Similarly, an address might be verified at block 408 by ensuring that it includes a street address, a city, and state, and a ZIP code. Alternatively, a deeper check might be performed to ensure that the identification of each of these elements is consistent with each other by verifying the presence of the identified city within the identified state and verifying that the identified address is within the identified ZIP code. At block 412, telephone and/or fax numbers may be checked by ensuring that they provide an area code and a seven-digit number, or checked more thoroughly by verifying with a directory that there is a correspondence between the address checked at block 408 and the number. Similar types of checks may be performed of email addresses block 416. In addition, insurance information for insurance that may be used in supporting healthcare services may be validated at block 420; such validation may sometimes including transmitting a validation request over the public network to the insurance provider, a feature that may be used in embodiments where relationships have been established with insurance providers to permit such information exchange.

A flow diagram is provided in FIG. 5 to illustrate steps that may be taken in obtaining an actuarial score at block 112 of FIG. 1. The actuary computer 216 is contacted at block 504 over the public network and provided with healthcare-purchaser information at block 508. This information is extracted from the information received from the purchaser at block 104 of FIG. 1 and permits demographic identifications to be made. For instance, this information may include the age of the purchaser, the sex of the purchaser, behavior characteristics of the purchaser, health characteristics of the purchaser, and the like. This information may then be used by the actuary computer 216 to determine a score that characterizes health risks of the purchaser in a simple quantitative way. This actuarial score is received at block 512 and may be applied at block 516 in matching the applicant to potential healthcare providers.

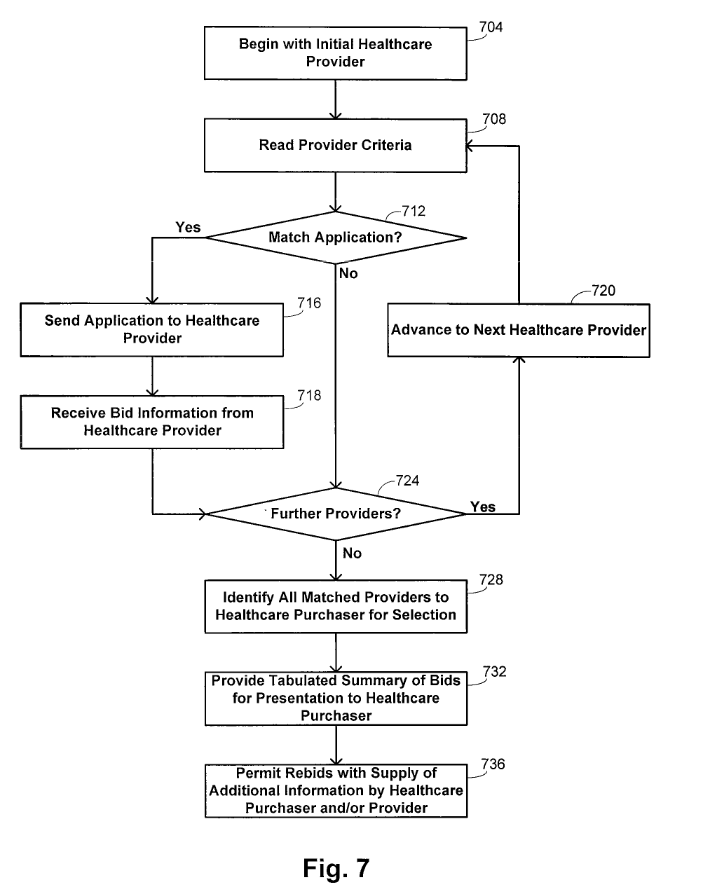

FIGS. 6 and 7 illustrate how information may be filtered in performing a match at block 116 of FIG. 1 and in transferring relevant information to identified healthcare providers at block 120. Briefly, the coordination system 224 runs a software filter that matches data in the purchaser tables 224 as extracted from the completed application with preset criteria established by the healthcare providers and stored in the provider tables 240. The correlation between different criteria 604 established by the providers and between the data extracted 608 from the application may permit a match with a plurality of different healthcare providers 612, as illustrated schematically in FIG. 6.

The flow diagram of FIG. 7 shows one way in which the structure shown in FIG. 6 may be used to filter the results. At block 704, the system begins by considering an initial healthcare provider, say provider 1 shown at block 612-1 of FIG. 6. The preset criteria for this provider are read at block 708 and checked at block 712 to see whether they match the data statements 608 extracted from the application information. If there is a match, application information is transmitted to that healthcare provider at block 716 and a record is kept that a match was found. Transmission of application information to the healthcare provider permits the healthcare provider to participate in bids for the purchaser's business. The application information generally includes sufficient information to allow the healthcare provider to evaluate the likely costs and risks associated with the desired healthcare service and to generate parameters defining its bid. For instance, the application information might include a specification by the healthcare purchaser of a maximum monthly amount that can be afforded towards the services, sometimes including amounts made available through the customer depository account 226 associated with the purchaser's loan. The application information may also be used to define a categorization of the healthcare purchase, according to such relevant criteria as whether the healthcare services will be for a newly married person, for a person with one child, for a self-employed person, for a new homeowner, for an individual with no major medical problems, and the like. The parameters that define the provider's bid may include certain restrictions, such as limitations on treatment options, limitations on drug types, and the like, in order to comply with the application criteria.

This process is repeated for all potential providers by making a check at block 724 whether there are additional providers to be considered. If so, the system advances to the next healthcare provider at block 720 and repeats the process.

This is done until there are no other providers to be considered, the system having identified all providers who have criteria consistent with information provided by the applicant and having transmitted application information to those providers. At block 728, the matched providers are accordingly identified to the healthcare purchaser 204 to permit the purchaser to make a selection. This may advantageously be accomplished through operation of the coordination system 224 by the bundling company 254 to provide a convenient comparison interface. As indicated at block 732, such an interface could include a software-generated table of the various bids with a tabular summary of prices, benefits, restrictions, and other program features to permit the healthcare purchaser to evaluate the offerings. In some instances, the coordination system 224 may also apply selection criteria to identify a “Top 5” or “Top 3” offerings to simplify the display. Such arrangements conveniently permit the healthcare purchaser to quickly analyze the proposed offerings in an unbiased environment to select the desired provider.

In some embodiments, a mechanism may also be provided for “rebids,” as indicated at block 736. Such rebids permit modifications of original proposed offerings by the healthcare providers based on additional information. This additional information may be provided by the healthcare purchaser in response to specific queries generated by the healthcare provider, may be volunteered by the healthcare purchaser after reviewing the original bids, or may be provided by the healthcare provider in different instances. Such a rebidding procedure may be iterative to progressively narrow the purchaser's search and may conveniently be performed in a real-time interactive fashion.

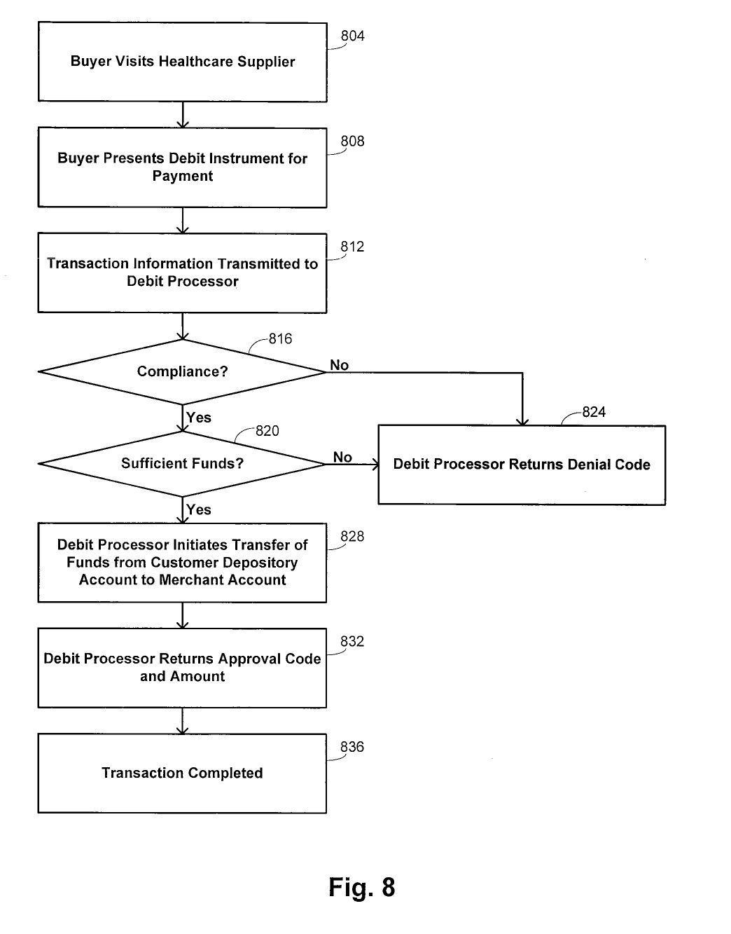

An illustration of how funds in the customer depository account 266 may be accessed to finance healthcare services and/or products is provided with the flow diagram of FIG. 8. Briefly, the funds are accessed by presentation of the debit instrument 264 at the time of purchase, with information from the debit instrument 264 being used to identify the customer depository account 266 and initiate a transfer of funds from that account to an account controlled by the supplier of the healthcare services and/or products.

Thus, at block 804, a healthcare purchaser who possesses a debit instrument 264 that identifies a customer depository account 266 visits a supplier of healthcare services and/or products at block 804 and presents the debit instrument at block 808 as a mechanism to provide payment for the healthcare products and/or services. The debit instrument 264 may conveniently comprise a magnetic-stripe card or smart card in some embodiments. A point-of-sale device at the supplier extracts information from the debit instrument, such as by reading the magnetic stripe of a magnetic-stripe card or by reading a chip embedded in a smart card. This information may identify the healthcare purchaser and the customer depository account 266 and is combined with other transaction information specifying a price for the services and/or products and forwarded to the debit processor 260 at block 812.

The information received by the debit processor 260 may be used to ensure compliance with terms of an applicable healthcare-financing program at block 816. For example, the healthcare-purchaser identification included as part of the transaction information may be used to identify whether there are restrictions on what type of healthcare products may be financed and whether there are restrictions on the suppliers that may be used when purchased in this way. If the transaction is not in compliance, return code may be returned to the supplier to refuse the transaction at block 824. For example, if the healthcare purchaser was not permitted to obtain specialist services without a preapproval, the debit processor 260 would cause the transaction to be denied if the transaction information lacked an indication that such preapproval had been granted.

Also, the ability of the debit processor 260 to analyze the transaction information further permits the use of other types of debit instruments, including even biometrics that identify the healthcare purchaser. For example, instead of presenting a magnetic-stripe card or smart card as a debit instrument, in some embodiments the healthcare purchase may allow his fingerprint, iris, or retina to be scanned, or to have his hand or facial geometry analyzed. This information is then bundled with the transaction information and analyzed by the debit processor 260 to identify the individual from stored biometric records and thereby determine whether any restrictions apply to the transaction, identify the customer depository account 266, etc.

Once full or partial compliance has been verified, the debit process 260 may query the customer depository account 266 to confirm that sufficient funds remain in the account to pay for the services and/or products. If not, the debit processor 260 returns a denial code at block 824 so that the transaction may be refused. If there are sufficient funds, the debit processor 260 initiates a transfer at block 828 of the funds to be used in paying for the services and/or products from the customer depository account 266 to an account controlled by the supplier. An approval code is returned to the point-of-sale device at block 832 to confirm that the transfer has been executed and that the supplier should proceed with supplying the services and/or products, completing the transaction at block 836.

Thus, having described several embodiments, it will be recognized by those of skill in the art that various modifications, alternative constructions, and equivalents may be used without departing from the spirit of the invention. Accordingly, the above description should not be taken as limiting the scope of the invention, which is defined in the following claims.

What is claimed is:

1. A method for coordinating an electronic healthcare application request between a healthcare purchaser and at least one of a plurality of healthcare providers, the method comprising:
receiving selection criteria from the plurality of healthcare providers;
receiving personal information from the healthcare purchaser at a coordination system over a public network;
filtering the personal information to identify the at least one of the plurality of healthcare providers, each of the at least one of the healthcare providers having selection criteria consistent with the personal information; and
transmitting the personal information over the public network to a computer system operated for the at least one of the plurality of healthcare providers.

2. The method recited in claim 1 wherein the personal information comprises health information.

3. The method recited in claim 1 further comprising:
transmitting the personal information over the public network to an actuary system;
receiving an actuarial score from the actuary system,
wherein filtering the personal information comprising ensuring the actuarial score is consistent with the selection criteria of the at least one of the healthcare providers.

4. The method recited in claim 1 further comprising receiving proposed terms for a relationship with the healthcare purchaser from the at least one of the plurality of healthcare providers.

5. The method recited in claim 4 further comprising generating a display for the healthcare purchaser to evaluate the proposed terms.

6. The method recited in claim 4 receiving a modification of the proposed terms for the relationship based on additional information.

7. The method recited in claim 1 further comprising:
receiving an identification of real property financed by the healthcare purchaser;
calculating a total loan value for the real property and specified healthcare costs; and
initiating a loan secured by the real property for the total value.

8. The method recited in claim 1 further comprising initiating issuance of a debit instrument to the healthcare purchaser that may be used at the at least one of the plurality of healthcare providers as part of a debit transaction for payment for healthcare products and/or services.

9. A computer-readable storage medium having a computer-readable program embodied therein for directing operation of a computer system for coordinating an electronic healthcare application request between a healthcare purchaser and at least one of a plurality of healthcare providers, the computer system including a communications system, a processor, and a storage device, wherein the computer-readable program includes:
instructions to receive selection criteria from the plurality of healthcare providers;
instructions to receive personal information from the healthcare purchaser over a public network with the communications system;
instructions to filter the personal information to identify the at least one of the plurality of healthcare providers with the processor, each of the at least one of the healthcare providers having selection criteria consistent with the personal information; and
instructions to transmit the personal information over the public network with the communications system to a computer system operated for the at least one of the plurality of healthcare providers.

10. The computer-readable storage medium recited in claim 9 wherein the personal information comprises health information.

11. The computer-readable storage medium recited in claim 9 wherein:
the computer-readable program further includes:
instructions to transmit the personal information over the public network with the communications system to an actuary system; and
instructions to receive an actuarial score from the actuary system; and
the instructions to filter the personal information comprise instructions to ensure the actuarial score is consistent with the selection criteria of the at least one of the healthcare providers.

12. The computer-readable storage medium recited in claim 9 wherein the computer-readable program further includes instructions for receiving proposed terms for a relationship with the healthcare purchaser from the at least one of the plurality of healthcare providers.

13. The computer-readable storage medium recited in claim 12 wherein the computer-readable program further includes instructions for generating a display for the healthcare purchaser to evaluate the proposed terms.

14. The computer-readable storage medium recited in claim 12 wherein the computer-readable program further includes instructions for receiving a modification of the proposed terms for the relationship based on additional information.

15. The computer-readable storage medium received in claim 9 wherein the computer-readable program further includes:
instructions for receiving an identification of real property financed by the healthcare purchaser;
instructions for calculating a total loan value for the real property and specified healthcare costs; and
instructions for initiating a loan secured by the real property for the total value.

16. The computer-readable storage medium recited in claim 9 wherein the computer-readable program further includes instructions for initiating issuance of a debit instrument to the healthcare purchaser that may be used at the at least one of the plurality of healthcare providers as part of a debit transaction for payment of healthcare products and/or services.
